(19) United States
(12) Patent Application Publication
(10) Pub. No.: US 2025/0249444 A1
(43) Pub. Date: Aug. 7, 2025

(54) METAL POLLUTION-RESISTANT CATALYST AND PREPARATION METHOD THEREFOR

(71) Applicants: CHINA PETROLEUM & CHEMICAL CORPORATION, Beijing (CN); SINOPEC RESEARCH INSTITUTE OF PETROLEUM PROCESSING CO., LTD., Beijing (CN)

(72) Inventors: Haitao SONG, Beijing (CN); Yan CHEN, Beijing (CN); Mingde XU, Beijing (CN); Qianqian LIU, Beijing (CN); Menglong FENG, Beijing (CN); Yuqing LIU, Beijing (CN)

(21) Appl. No.: 18/695,288

(22) PCT Filed: Sep. 28, 2022
(86) PCT No.: PCT/CN2022/122054

§ 371 Date: Mar. 25, 2024

(30) Foreign Application Priority Data
Sep. 30, 2021 (CN) 202111158872.7

(51) Int. Cl. B01J 37/02; B01J 23/34; B01J 35/40; B01J 35/51; B01J 35/61; B01J 35/63; B01J 37/00; B01J 37/08; C10G 11/18

(52) U.S. Cl. CPC B01J 37/0207; B01J 23/34; B01J 35/40; B01J 35/51; B01J 35/613; B01J 35/615; B01J 35/633; B01J 37/0072; B01J 37/0236; B01J 37/08; C10G 11/18

(57) ABSTRACT

A metal pollution-resistant catalyst, its preparation and application are provided. The catalyst consists of a first alumina comprising a modified metal Mn and a second alumina. The ratio of the integral areas of the two peaks at 3670 cm⁻¹ and 3730 cm⁻¹ in the infrared spectroscopy of the catalyst is 1-5:1. The method for preparing the catalyst comprises a step of forming a slurry of an acid-soluble first alumina, a non-acid-soluble second alumina, water and optionally acid and a modified metal oxide. The metal pollution-resistant catalyst and the particle containing a catalytic cracking active component form a catalytic cracking catalyst, useful for catalytic cracking of hydrocarbon oil containing pollution metals. In the case of nickel pollution, catalytic cracking of hydrocarbon oil can reduce the ratio of hydrogen to methane.

### TECHNICAL FIELD

The present invention belongs to the technical field of catalytic cracking, and relates to a catalyst increasing the nickel tolerance of catalytic cracking of a heavy oil, its preparation and application.

### BACKGROUND TECHNOLOGY

Fluid catalytic cracking (FCC) technology has become an important means of secondary processing of heavy oil in the world today due to its characteristics of the low investment, the strong adaptability of raw materials and the simple operation. Therein catalytic cracking catalysts play a crucial role. With the increasing depletion of high-quality light crude oil resources worldwide and the improvement of the delayed coking capacity, refineries mix a large proportion of the inferior crude oil such as the residual oil, the coking wax oil and the deasphalted oil, in catalytic cracking devices in order to increase efficiency. This has seriously affected the stable operation of catalytic cracking devices and the distribution of cracking products, and thus puts forward higher requirements for the performance of catalytic cracking catalysts.

Since a residual oil feed usually contains the pollutant metals Ni and V, during the use of catalytic cracking catalysts, heavy metals such as nickel and vanadium in the feedstock oil will continuously deposit on the surface of the catalysts, causing certain toxic effects on the catalysts. With the increased Ni content in catalysts in the catalytic cracking devices, the catalysts exhibit a strong catalytic dehydrogenation effect. The ratio of hydrogen to methane increases, and the yields of hydrogen and coke increase. High value products such as gasoline and LPG are affected. In addition, a high hydrogen yield will also cause the gas compressor to bear a greater pressure. During the use of catalysts, new nickel will deposit continuously, so there is always a portion of nickel that can be completely or partially reduced as “active nickel”. Each refinery suppresses the dehydrogenation toxicity of this portion of “active nickel” by adding an additional passive Ni agent during the reaction process. The passive Ni agent are often injected into cracking reactors in an oil-soluble or water-soluble liquid state. During the reaction process, its effective component comes into contact with the catalyst surface and interacts with the “active nickel” on the catalyst surface to deprive the toxicity. Since antimony has the best effect of passivating the toxicity of nickel, currently commonly used metal passivators include the antimony type metal passivator. Research suggests that antimony forms stable nickel antimonite NiSbₓO_{y} with the reduced-state nickel, thereby changing the electronic properties of nickel and passivating the dehydrogenation activity of Ni.

However, when an antimony type nickel passivator is added to a catalytic cracking device, the leaching toxicity of antimony metal of the catalytic cracking waste catalyst exceeds the Class III standard limit of the Surface Water Quality Standard (GB/T14848-2017): *100 antimony 0.5 mg/L, resulting in a certain environmental risk from the catalytic cracking waste catalyst. In addition, adding the agent passivating nickel by antimony to the device will easily cause Sb to condense at the valve, which has some impacts on the control of the device. Therefore, in the face of increasingly strict environmental and safety requirements, being also able to passivate the active nickel on the catalyst surface without the use of the additional antimony Sb and using a catalyst with a high nickel tolerance are an important means to reduce hazardous wastes from the source.

U.S. Ser. No. 14/134,614 relates to a B-containing anti-nickel catalyst technology reported by Basf. Although the boron component has an excellent effect on passivating nickel, boric acid has a particularly big destructive effect on the molecular sieve and the catalyst activity, and is introduced in a particularly low amount with the precondition of not damaging the catalyst activity, thus having a limited effect on reducing the dehydrogenation activity of nickel.

U.S. Pat. No. 4,919,787A introduces a catalytic cracking catalyst containing a metal passivating material which includes a precipitated porous rare earth oxide, alumina and aluminum phosphate precipitate. The passivating materials can be applied on the cracking catalyst, and can be a part of the substrate of the cracking catalyst or can be added as discrete particles in the cracking operations. According to the introduction, this material is beneficial for stabilizing the catalytic activity, but its effect on reducing the ratio of hydrogen to methane is limited.

CN102019198A introduces a solid co-catalyst which is prepared from 10 to 50% by weight of highly active lanthanum oxide, 0.1 to 20% by weight of fine-particle antimony oxide, 1 to 30% by weight of highly active Y molecular sieve modified on the outer surface by rare earth, and the balance of alumina-based binder consisting of acidified pseudo-boehmite and/or aluminum sol. The co-agent further contains some Sb, and has a certain effect on resisting the dehydrogenation activity of nickel.

CN103785346B provides a metal collector and its preparation method and application. The metal collector contains magnesium oxide, alumina with a gradient pore distribution, a lanthanide rare earth metal oxide and/or a transition metal oxide, and at least a part of the magnesium oxide forms a magnesium aluminum spinel structure. The use of this metal collector can slow down the damage of vanadium to the catalytic cracking catalyst, improve the selectivity of coke and dry gas, and increase the total liquid product yield.

### SUMMARY OF THE INVENTION

The inventors have found by research that the nickel pollution in the catalytic cracking catalyst is mainly deposited on the outer surface of the catalyst. When it has not yet been well combined and stabilized with a substrate of the catalyst, it has a certain degree of surface migration property and contact transfer property. Therefore, introducing a nickel-tolerant microsphere with a better nickel-tolerant surface into the catalyst can increase the nickel stability of the entire catalyst, thereby significantly reducing the performance of the ratio of hydrogen to methane under condition of a considerable nickel pollution.

It is found by research that alumina with a surface rich in hydroxyl itself has a certain nickel-tolerant property. The inventors have found through a further research that adding a certain amount and preferably a certain particle size of a non-acid-soluble second alumina material to an acid-soluble alumina can stabilize the surface of alumina and stabilize the nickel-tolerant capacity through a specific coordination between the two.

Furthermore, it is found by research that adding a certain amount of manganese to the continuous phase alumina material in the metal-resistant catalyst can further improve the performance of the metal-resistant catalyst in terms of reducing the ratio of hydrogen to methane under a nickel pollution. Particularly, without being limited by any known theory, the introduction of manganese sources by means of the combination of manganese ore (mainly MnO) and manganese salts can achieve an excellent equilibrium technical effect, for example in terms of the aspects of reducing the ratio of hydrogen to methane and affecting the catalyst activity.

The technical problem to be solved by the present invention is to provide a catalytic cracking metal pollution-resistant catalyst, which has a lower ratio of hydrogen to methane when a catalytic cracking is performed in the presence of nickel pollution.

Another technical problem to be solved by the present invention is to provide a method for preparing the metal pollution-resistant catalyst.

Another technical problem to be solved by the present invention is to provide a catalytic cracking catalyst containing the above metal pollution-resistant catalyst, which has a lower ratio of hydrogen to methane, and has lower yields of dry gas and coke.

The present invention provides accordingly a composition for the catalytic cracking of heavy oil, particularly suitable for preparing the required catalytic cracking metal pollution-resistant catalyst. The composition includes an acid-soluble first alumina and a non-acid-soluble second alumina present in a weight ratio of greater than or equal to 2:1. The acid-soluble first alumina source has an acid solubility of more than 90%, and the non-acid-soluble second alumina has an acid solubility of less than 50%, wherein the acid solubility of the alumina is tested as follows:
mixing an alumina sample with water at a solid content of 10% to obtain hydrous alumina,
acidifying and dissolving the hydrous alumina and hydrochloric acid with a concentration of 35% by weight in a ratio of 1:0.2 by weight of dry alumina to hydrochloric acid at 25° C. for 60 minutes, followed by
separating an undissolved alumina using a centrifuge,

acid solubility=(1-dry weight of alumina not acidified and dissolved÷dry weight of alumina source sample)×100%.

According to one embodiment of the present invention, the mass ratio of the acid-soluble first alumina to the non-acid soluble second alumina in the composition is 5: 1 to 20: 1.

According to one embodiment of the present invention, the composition further includes a material containing a modified metal Mn, which, based on the oxide MnO, accounts for 5-50%, preferably 10-40% by weight of the total weight of the material containing the modified metal Mn and the acid-soluble first alumina.

According to one embodiment of the present invention, the material containing the modified metal Mn is from manganese ore and/or other manganese compounds (e.g., manganese salts or/and manganese hydroxide), wherein, the main state of Mn in the manganese ore is MnO. As stated above, the inventors have found that the introduction of manganese sources by means of the combination of manganese ore (mainly MnO) and manganese salts can achieve an excellent equilibrium technical effect, and therefore, preferably, in one embodiment, the ratio of the manganese source from manganese ore (manganese oxide) and the manganese source from manganese salts is 5:1 to 1:5 in the material containing the modified metal Mn.

According to one embodiment of the present invention, the manganese ore includes but is not limited to one or more of soft manganese ore, hard manganese ore, water manganese ore, brown manganese ore, black manganese ore, rhodochrosite, etc., as well as other high-Mn intermediate industrial materials or products, such as electrolytic manganese, etc., preferably manganese ores or materials with a Mn content of greater than 60% based on MnO. The other manganese compounds refer to one or more of manganese salts and manganese hydroxide.

According to the present invention, the acid-soluble first alumina has an acid solubility of greater than 90%, which can be an acid-soluble alumina in solid form or the form of aluminum-containing sol itself. The acid-soluble first alumina in solid form can be one or more of gibbsite, boehmite, pseudo boehmite and bayerite, and the aluminum-containing sol can be one or more of amorphous aluminum gel, aluminum sol and phosphorus aluminum gel.

According to the present invention, the non-acid-soluble second alumina has an acid solubility of less than 50%, preferably an acid solubility of <35%, or an acid solubility of ≤30%, for example, 5-30%. The non-acid-soluble second alumina is preferably a non-acid-soluble second alumina with a large particle size and a large pore size, the median particle size of which is 1 μm-12 μm, preferably 4 μm-10 μm, for example, 4 μm-9 μm. The average pore size of the non-acid-soluble second alumina is preferably 4 nm-12 nm, with a specific surface area of >230 m²/g, for example >250 m²/g or 280-350 m²/g and a pore volume of >0.35 ml/g, for example 0.50-0.67 ml/g.

The non-acid-soluble second alumina may be one or more of pseudo boehmite, boehmite, γ alumina materials, etc., and is not limited thereto.

According to one embodiment of the present invention, in the metal pollution-resistant catalyst, the content of the material containing the modified metal Mn is 10-35% by weight, for example 15-30% by weight, and the content of the soluble alumina is 45-65% by weight, for example 50-60% by weight. The weight ratio of the soluble alumina to the modified metal oxide is preferably 1.5-10:1, for example 1.5-4:1.

According to one embodiment of the present invention, the composition further contains an additive oxide, preferably one or more of the oxides of P, B, RE. The additive oxide is preferably added in the form of being fixed to the non-acid-soluble second alumina, and based on the oxide of the additive element, the content of the additive compound in the non-acid-soluble second alumina is not more than 20% by weight, for example 0.5% by weight to 10% by weight (based on the total weight of the alumina and the additive oxide in the non-acid-soluble second alumina), wherein, the oxide of P is based on P₂O₅; the oxide of B is based on B₂O₃; the oxide of RE is based on RE203. In one embodiment, the phosphorus content in the non-acid-soluble second alumina does not exceed 10% by weight, for example 0.05-10% by weight; the content of B does not exceed 5% by weight, for example 0.01-2% by weight. The presence of the additive oxide in the non-acid-soluble second alumina can better reduce the ratio of hydrogen to methane, and compared with the catalyst without the additive, it can better ensure the synergistic effect with the main catalyst, resulting in a better cracking effect.

According to one embodiment of the present invention, the composition further contains an alkaline earth metal oxide as an adjuvant, wherein the alkaline earth metal is one or more of Mg, Ca, Sr and Ba. For example, the alkaline earth metal oxide adjuvant is calcium oxide and/or magnesium oxide and/or strontium oxide. The content of the alkaline earth metal oxide adjuvant does not exceed 20% by weight, preferably does not exceed 15% by weight, for example 0-10% by weight, for example 2-10% by weight, of the total weight of the metal pollution-resistant catalyst based on the oxide.

According to one embodiment of the present invention, the alkaline earth metal originates from one or more of alkaline earth metal hydroxide, alkaline earth metal salt, alkaline earth metal oxide, or natural mineral containing alkaline earth metal, such as hydrotalcite. Preferably, the alkaline earth metal adjuvant is preferably in the acid-soluble first alumina having a content of the alkaline earth metal oxide adjuvant not higher than the content of the material containing the modified metal Mn.

Furthermore, the present invention provides a metal pollution-resistant catalyst for catalytic cracking of heavy oil, which is obtained by the composition for catalytic cracking of heavy oil in the present invention through spray drying and calcining. The catalyst includes alumina and a material containing the modified metal Mn;

The content of the material containing the modified metal Mn is 5-⁴0% by weight, based on MnO. After calcined at 550° C. for 3-4 hours, the composition was tested for surface hydroxyl groups using an infrared spectroscopy. There is a clear bimodal characteristic at 3670 cm⁻¹ and 3730 cm⁻¹ (the peak at 3670 cm⁻¹ is a surface-OH group of type IIIb with 0.75 positive charge, and the peak at 3730 cm⁻¹ is a surface-OH group of type IIa with 0.25 positive charge, and the two peaks have the ratio of the integral areas of 1-6:1, for example 1-5:1).

The method for the measurement of the surface hydroxyl characteristics is as follows: first, pressing the sample into a self-supporting sheet, weighing 15-20 mg of the sample, then putting the sample sheet into a reaction cell, purifying it under a vacuum condition of 10⁻³ Pa and a temperature of 450° C. for 3 hours, followed by reducing the temperature to 90° C. to measure its infrared hydroxyl spectrum.

According to one embodiment of the present invention, the bulk specific weight (bulk density) of the metal pollution-resistant catalyst can be between 0.75 and 1.15 g/ml.

According to one embodiment of the present invention, the specific surface area of the metal pollution-resistant catalyst may be 100-250 m²/g.

According to one embodiment of the present invention, the water drop pore volume of the metal pollution-resistant catalyst may be 0.18-0.35 ml/g.

According to one embodiment of the present invention, the metal pollution-resistant catalyst may contain silica which can be that carried by the raw material or that added additionally.

Preferably, the SiO₂ content in the metal pollution-resistant catalyst of the present invention does not exceed 3% by weight.

Preferably, the content of sodium oxide in the metal pollution-resistant catalyst does not exceed 0.3% by weight.

The present invention also provides a method for preparing a metal pollution-resistant catalyst for heavy oil cracking and conversion, wherein a first embodiment comprises following steps:
(1) forming a slurry of an acid-soluble first alumina, a non-acid-soluble second alumina, water and optionally acid, referred to as a first slurry; the solid content of the first slurry is preferably 8-20% by weight. Preferably, a molar ratio of dissociable H⁺ to total alumina sources (including both gel-soluble alumina and non-gel-soluble alumina) calculated based on alumina in the first slurry is 0.1-0.3:1. The acid-soluble first alumina may be a solid acid-soluble first alumina and/or an aluminum-containing colloid.

When the acid-soluble first alumina is an acid-soluble alumina comprising solids, it is preferred to add an acid to the first slurry to acidify and peptize the solid gel-soluble alumina source, wherein the molar ratio of the dissociable H⁺ in the acid to the sum of the solid acid-soluble first alumina and the non-acid-soluble second alumina calculated based on alumina is 0.05-0.3:1. Preferably, the molar ratio of acid to the sum of the solid acid-soluble first alumina and the non-acid-soluble second alumina calculated based on alumina is 0.12-0.18:1; the weight ratio of the acid-soluble first alumina to the non-acid-soluble second alumina calculated based on alumina is preferably 1.5:1-20:1, for example 3:1-10:1;
(2) mixing a product (the first slurry) obtained in step (1) with a material containing a modified metal Mn, for example by adding a dispersion liquid of the material containing the modified metal Mn, stirring evenly to form a second slurry; preferably, a solid content of the formed second slurry is 10-20% by weight,
(3) spray drying, calcining;
or, a second embodiment comprises following steps:
(S1) introducing a source of a material containing a modified metal Mn to an acid-soluble first alumina to form a slurry having a solid content of 8-30% by weight, stirring, for example, for 10 min to 60 min, giving a modified acid-soluble alumina source;
(S2) forming a slurry of a modified acid-soluble alumina source, a non-acid-soluble second alumina, optionally acid, and water, referred to as a third slurry, a solid content of the third slurry preferably being 10-20% by weight; preferably, a molar ratio of dissociable H⁺ to total alumina sources (including the acid-soluble first alumina and the non-acid-soluble second alumina) calculated based on alumina in the third slurry is 0.1-0.3:1; the acid-soluble first alumina may be a solid acid-soluble first alumina and/or an aluminum-containing colloid.

According to one embodiment of the present invention, the acid-soluble first alumina includes a solid acid-soluble alumina; an acid is introduced to the third slurry formed for acidifying and peptizing so as to peptize the solid acid-soluble first alumina under an action of acid. Preferably, a molar ratio of the dissociable H⁺ in the introduced acid to the sum of the solid acid-soluble first alumina and the non-acid-soluble second alumina calculated based on alumina is 0.1-0.3:1;
(S3) spray drying the third slurry, and calcining.

A method for preparing a metal pollution-resistant catalyst according to any one of the above technical solutions, wherein the first alumina in the metal-resistant catalyst is present as a continuous phase, and Mn and alkaline earth metal are present in a dispersed phase or uniformly in the first alumina. The second alumina is dispersed in the first alumina system, that is, the second alumina is present in a dispersed form.

A method for preparing a metal pollution-resistant catalyst according to any one of the above technical solutions, wherein the acid may be, for example, one or more of hydrochloric acid, sulfuric acid, nitric acid, but is not limited thereto.

A method for preparing a metal pollution-resistant catalyst according to any one of the above technical solutions, wherein the material containing modified metal Mn is an oxide of the modified metal or a salt of the modified metal, and the salt of the modified metal includes but is not limited to one or more of nitrate, chloride and sulfates of the modified metal element.

Preferably, the solid acid-soluble first alumina has an average pore size (diameter) of 2-10 nm; a specific surface area of >150 m²/g, for example, 200-300 m²/g; a pore volume of >0.30 ml/g, for example, 0.35-0.45 ml/g.

Preferably, the ratio of the acid-soluble first alumina calculated based on alumina to the modified metal oxide is 1.5-20:1 or 2:1-10:1 by weight;

According to one embodiment of the present invention, in the method for testing the acid solubility (or gel solubility), specifically:
a sample of an alumina source is mixed with water at a solid content of 10%, and acidified and peptized at 25° C. for 60 min according to a mass ratio of alumina dry basis to hydrochloric acid (concentration: 35% by weight) of 1:0.2. Then, the alumina that has not yet been peptized is separated by a centrifuge, acid solubility=(1-dry basis weight of non-peptized alumina÷dry basis weight of alumina source sample)×100%,
wherein, the dry basis is measured as follows: the weight of the solid product obtained after calcining the substance at 800° C. for 1 hour.

The non-acid-soluble second alumina may contain one or more of the additive elements P, B, RE elements. For example, the non-acid-soluble second alumina is a macroporous alumina containing one or more of the oxides of P, B, RE elements, and/or an active alumina material containing one or more of the oxides of P, B, RE elements, but is not limited thereto. The manner of the introduction of additive elements may be adding them during the preparation of the non-acid-soluble second alumina material, or introducing them through impregnation after the non-acid-soluble second alumina is prepared, and fixing these non-aluminum additive elements. The additive elements may also be fixed by calcination of the non-acid-soluble second alumina, such as calcination at 500-650° C. for 1-4 hours.

Preferably, one or more of compounds of P, B, RE elements (these elements are referred to as additive elements) are introduced into the non-acid-soluble second alumina, so that the additive elements are fixed in the alumina matrix. The compounds of the additive elements calculated based on oxides accounts for 0-20% by weight of the non-acid-soluble second alumina calculated based on alumina. Preferably, the compounds of the additive elements calculated based on oxides accounts for 0.5% to 10% by weight of the non-acid-soluble second alumina calculated based on alumina.

According to one embodiment of the present invention, the weight ratio of the acid-soluble first alumina to the non-acid-soluble second alumina, calculated based on alumina, is preferably 1.5:1 to 20:1 or 2:1 to 20:1 or 2:1 to 10:1.

According to one embodiment of the present invention, the method for preparing the metal pollution-resistant catalyst may further include a washing step. The washing is carried out after spray drying, preferably after calcination, and water may be used for washing. For example, the washing reduces the content of the anion (the anion is an acid radical, for example, a sulfate) in the catalyst, preferably, the content of the acid radical in the obtained metal pollution-resistant catalyst is decreased to be no more than 3% by weight.

According to one embodiment of the present invention, the method for preparing the metal pollution-resistant catalyst further comprises the step of introducing an alkaline earth metal source. The alkaline earth metal source may be added at any step during the preparation process without any particular limitation. For example, the alkaline earth metal source can be introduced in step (1) and/or step (2). Alternatively, the alkaline earth metal source is added in step (S1) and/or step (S2). The alkaline earth metal is, for example, one or more of Ca, Mg, Ba, Sr. The alkaline earth metal source is, for example, one or more of alkaline earth metal, oxide of alkaline earth metal, and salt of alkaline earth metals. The content (addition ratio) of the alkaline earth metal in the catalyst is 0-20% by weight, for example, not more than 15% by weight or 0-10% by weight, calculated based on oxides. Preferably, the alkaline earth metal source is added to a slurry containing the acid-soluble first alumina material and the non-acid-soluble second alumina material.

Adding an alkaline earth metal compounds helps improving the nickel-resistant performance of the metal pollution-resistant catalyst, and promotes the stability of the long-term operation in the actual catalytic cracking device. Alkaline earth metal oxides have a desulfurization property and a vanadium-resistant property, but an excessive addition amount will affect the performance of the metal-resistant catalyst per se of reducing the dehydrogenation effect of nickel.

The present invention further provides a catalytic cracking catalyst, comprising a microspherical particle containing a catalytic cracking active component and the metal pollution-resistant catalyst described in the present invention. The mass ratio of the metal pollution-resistant catalyst to the microspherical particle containing the catalytic cracking active component in the catalytic cracking catalyst is 3:97-20:80.

The microspherical particle containing the catalytic cracking active component may be a conventional catalytic cracking catalyst, for example, the microspherical particle containing the catalytic cracking active component contains 20-60% by weight of the cracking active component and 80-90% by weight of substrate. The cracking active component is, for example, one or more of Y-type molecular sieve, R molecular sieve and MFI-structured molecular sieve. The substrate is, for example, one or more of clay, alumina, aluminium oxide, zirconia. The microspherical particle containing the catalytic cracking active component has an average particle size of, for example, 60-80 microns.

The catalytic cracking metal pollution-resistant catalyst provided by the present invention has a good nickel pollution-resistant effect. When combined with a conventional catalyst in a certain proportion, it can still have a good nickel-resistant effect under the conditions of a high nickel content pollution and a lower modified metal, and reduce the ratio of hydrogen to methane in a hydrocarbon oil conversion.

The method for preparing the catalytic cracking metal pollution-resistant catalyst provided by the present invention can obtain a catalyst with a better effect resistant to the metal pollution under the condition of having a lower content of the modified metal.

The catalytic cracking metal pollution-resistant catalyst provided by the present invention, when mixed with a conventional catalytic cracking catalyst, can be used in the catalytic cracking of heavy oil under the condition of a higher content of the nickel pollution, and can significantly reduce the ratio of hydrogen to methane, as well as also reduce the yields of dry gas, hydrogen and/or coke. In a preferred case, it may have a higher yield of gasoline and LPG (liquefied petroleum gas).

The catalytic cracking metal pollution-resistant catalyst provided by the present invention may also have a good vanadium pollution-resistant effect. After being mixed with a cracking catalyst containing a Y-type molecular sieve, it can be used for a heavy oil conversion under the condition of vanadium and a higher content of the nickel pollution. Compared with the blank sample (without a metal pollution-resistant catalyst), it can have a lower ratio of hydrogen to methane, a lower yield of dry gas and/or a lower yield of coke and/or a lower yield of hydrogen. In a preferred case, it can have a good conversion activity and higher yields of gasoline and the liquefied petroleum gas. Compared with the catalytic cracking catalyst containing the existing metal pollution-resistant catalyst, it can have a significantly lower ratio of hydrogen to methane, and can have a higher conversion activity, as well as a good selectivity.

### DESCRIPTION OF THE DRAWINGS

FIG. 1 is a hydroxyl infrared spectrogram of 3600-3900 cm⁻¹ of the metal-resistant catalyst prepared in Example 1 after being dried and calcined at 550° C./3 h; as shown in the figure, there is a clear bimodal distribution at the wave numbers of 3670 cm⁻¹ and 3730 cm⁻¹.

FIG. 2 is a hydroxyl infrared spectrogram of Comparative Example 4.

FIG. 3 is an XRD spectrogram of Example 5, wherein there are clear peaks at 19°, 31.5°, 37°, 45.3°, 56°, 590 and 65.7°.

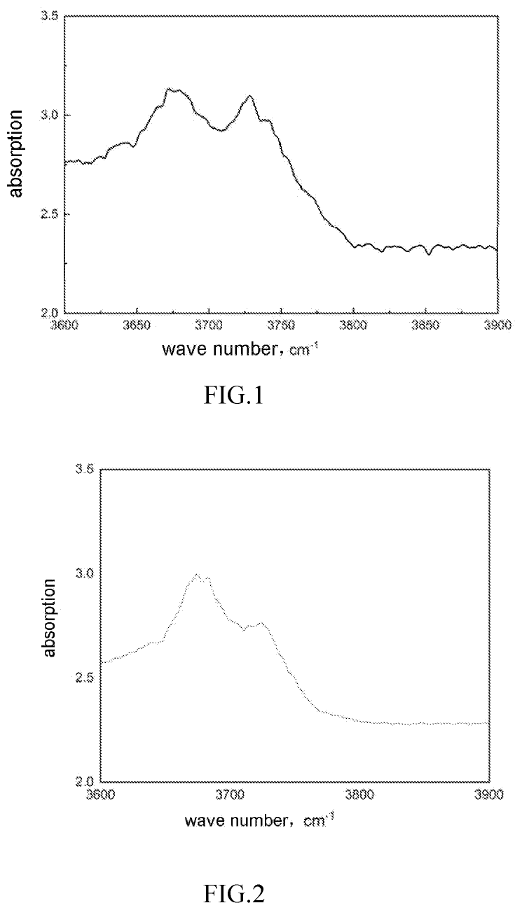

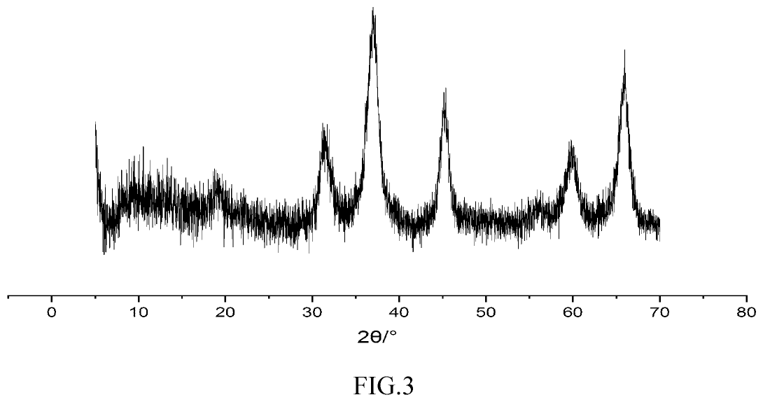

### SPECIFIC EMBODIMENTS

The following examples will further illustrate the present invention, but will not limit the present invention accordingly.

The raw materials used in the following examples are as follows:

Pseudo-boehmite is a product of Shandong Aluminum Co., Ltd. with a solid content of 67.0% by weight, an acid solubility of 98%, a pore volume of approximately 0.35 ml/g, a specific surface area of 248 m²/g, an average pore diameter of 3 nm, and an impurity SiO₂ content of 2.1%.

Non-acid-soluble alumina is from Qilu Branch of Sinopec Catalyst Co., Ltd., with an acid solubility of 12%, a pore volume of 0.37 ml/g, a specific surface area of 315 m²/g, an average pore diameter of 6 nm, an average particle size of 8.2 μm.

Alumina sol is a product of Qilu Branch of Sinopec Catalyst Co., Ltd., with an Al₂O₃ content of 21.5% by weight. It is in a colloidal state with a colloidal solubility of 100%.

Manganese chloride is a commercial product of industrial manganese chloride tetrahydrate.

The manganese oxide ore powder is purchased from a manganese industry company in Hunan Province, China, and its composition is shown in Table 1:

| sample name | manganese ore |
|---|---|
| Na₂O. %(W) | 0.136 |
| MgO. %(W) | 0.273 |
| Al₂O₃. %(W) | 2.64 |
| SiO₂. %(W) | 4.83 |
| P₂O₅. %(W) | 0.07 |
| SO₃. %(W) | 0.1 |
| K₂O. %(W) | 1.35 |
| CaO. %(W) | 0.311 |
| MnO. %(W) | 82.65 |
| Fe₂O₃. %(W) | 5.14 |
| BaO. %(W) | 2.29 |
| PbO. %(W) | 0.21 |

The non-acid-soluble second alumina A and the non-acid-soluble second alumina B are obtained from Qilu Branch of Sinopec Catalyst Co., Ltd.

Non-acid-soluble second alumina A: alumina with a basic pseudo-boehmite structure, which has a median particle size of 8.4 μm, a specific surface area of 305 m²/g, a pore volume of 0.81 ml/g, an average pore size of 8.6 nm, an acid solubility of 7%.

Non-acid-soluble second alumina B: alumina with a basic pseudo-boehmite structure, which has a P content of 5.3%, a median particle size of 6.3 μm, a specific surface area of 325 m²/g, a pore volume of 0.64 ml/g, an average pore size of 4.8 nm, an acid solubility of 15%.

SB powder is purchased from SASOL company, with a BET surface area of 262 m²/g, a pore volume of 0.44 ml/g, an average pore size of 8 nm, an acid solubility of 95%, and can be an acid-soluble macroporous alumina material with a median particle size of approximately 6.6 M.

In the various examples and comparative examples, the content of each component in the sample is detected by an X-ray fluorescence method, as shown in ASTM D7085-04 (2010) Guide for the Standard of Chemical Element Detection in Fluidized Catalytic Cracking Catalysts—X-ray Fluorescence Spectroscopy Detection Guide.

Detection of the specific surface area of the sample: see: NB/SH/T 0959-2017 Detection of Specific Surface Area of Catalytic Cracking Catalysts, Static Nitrogen Adsorption Capacity Method; The average pore size is determined by the low-temperature nitrogen adsorption-desorption method, and the pore size distribution is calculated by BJH method.

The pore volume is detected by the water drop method, NB/SH/T 0955-2017 Detection of Pore Volume of Catalytic Cracking Catalysts Water Drop Method.

The particle size and its distribution are detected using a laser particle size method, see NB/SH/T 0951-2017 Detection of Particle Size Distribution of Catalytic Cracking Catalysts Laser Scattering Method. Therein, for example, for the acid-soluble alumina, a non-aqueous solvent such as ethanol or ether are required for testing.

Wear index measurement: NB/SH/T 0964-2017 Detection of Wear Index of Catalytic Cracking Catalysts Straight Tube Method.

### EXAMPLES

### Preparation Example 1

To 200 parts by mass (based on a dry basis, a product of Shandong Aluminum Company) of pseudo boehmite, deionized water and 24 parts by mass of hydrochloric acid with a concentration of 35% by mass were added, and an acidified boehmite with a solid content of 12% by mass was prepared through beating; then, 100 parts by mass (based on a dry basis) of an aluminum sol, 340 parts by mass (based on a dry basis) of kaolin and 360 parts by mass (based on a dry basis) of DASY2.0 molecular sieve (a product of Qilu Branch of Sinopec Catalyst Co., Ltd.) were added, stirred for 0.5 h, and spray dried, then calcined at 550° C. for 2 h, followed by washing with ammonium chloride solution with a concentration of 2% by mass twice, to give a catalytic cracking catalyst microsphere, which is recorded as Cat-A. The basic chemical composition of Cat-A is shown in Table 2. The chemical composition is detected by X-ray fluorescence (XRF). See ASTM D7085-04(2010) Guide for the Standard of Detection of Chemical Elements in Fluid Catalytic Cracking Catalysts—Guide for Detection by X-Ray Fluorescence Spectrometry.

TABLE 2

| component name | Cat-A |
|---|---|
| Cl. %(W) | 0.490 |
| Na₂O. %(W) | 0.0458 |
| Al₂O₃. %(W) | 53.4 |
| SiO₂. %(W) | 42.7 |
| P₂O₅. %(W) | 0.107 |
| SO₃. %(W) | 1.67 |
| K₂O. %(W) | 0.196 |
| CaO. %(W) | 0.057 |
| TiO. %(W) | 0.288 |
| La₂O₃. %(W) | 0.309 |
| CeO₂. %(W) | 0.607 |

### Example 1

(1) 55 g (based on Al₂O₃) of pseudo-boehmite and 12 g of non-acid-soluble second alumina material A (based on oxide) were added to deionized water to formulate a slurry with a solid content of 14% by weight, which was stirred for 60 min at a condition of 300 r/min (referring to the stirring speed, the same below) to evenly disperse. Then, 9 g of hydrochloric acid (containing 35% by weight of HCl) were added, and stirred for 60 min at the condition of 250 r/min to fully peptize the acid-soluble first alumina material to give a first slurry.

(2) 10 g of manganese trichloride (based on MnO) and 18 g of manganese ore powder (wherein Mn is about 15 g calculated based on MnO) were added to deionized water, fully dispersed and added to the first slurry, which was fully stirred before the addition of 5 g of MgO (based on a dry basis) to give a second slurry with a solid content of 13% by weight;

(3) The second slurry was spray dried and molded, and then calcined at 550° C. for 4 h to obtain a metal-resistant catalyst A1, wherein the microspheres with particle sizes in the range of 0-149 μm accounted for 91% by volume, and the microspheres with particle sizes in the range of 0-40 μm accounted for 17% by volume. The average particle size (APS) of the microspheres was 72 μm.

The formulation, the preparation parameters, the bulk density and the wear index of A1 are listed in Table 3.

### Example 2 (without Alkaline Earth Metal)

(1) 50 g (based on Al₂O₃) of pseudo-boehmite and 22 g of non-acid-soluble second alumina material B (based on oxide) were added to deionized water to formulate a slurry with a solid content of 13% by weight, which was stirred for 60 min at a condition of 300 r/min (referring to the stirring speed, the same below) to evenly disperse. Then, 10 g of hydrochloric acid (containing 35% by weight of HCl) were added, and stirred for 60 min at the condition of 250 r/min to fully peptize the acid-soluble first alumina material to give a first slurry.

(2) 10 g of manganese trichloride (based on MnO) and 18 g of manganese ore powder (wherein Mn is about 15 g calculated based on MnO) were added to deionized water, fully dispersed and then added to the first slurry to give a second slurry with a solid content of 14% by weight;

(3) The second slurry was spray dried and molded, and then calcined at 550° C. for 4 h to obtain a metal-resistant catalyst A1, wherein, the microspheres with particle sizes in the range of 0-149 μm accounted for 93% by volume, and the microspheres with particle sizes in the range of 0-40 μm accounted for 16% by volume. The average particle size (APS) of the microspheres was 68 μm.

The formulation, the preparation parameters, the bulk density and the wear index of A1 are listed in Table 3.

### Example 3 (Pure Manganese Powder)

(1) 53 g (based on Al₂O₃) of pseudo-boehmite and 12 g of non-acid-soluble second alumina material A (based on oxide) were added to deionized water to formulate a slurry with a solid content of 14% by weight, which was stirred for 60 min at a condition of 300 r/min (referring to the stirring speed, the same below) to evenly disperse. Then, 9 g of hydrochloric acid (containing 35% by weight of HCl) were added, and stirred for 60 min at the condition of 250 r/min to fully peptize the acid-soluble first alumina material to give a first slurry.

(2) 30 g of manganese ore powder (wherein Mn is about 25 g calculated based on MnO) were added to deionized water and then fully ground into a slurry, which was added to the first slurry and fully stirred before the addition of 5 g of MgO (based on a dry basis) to give a second slurry with a solid content of 16% by weight;

(3) The second slurry was spray dried and molded, and then calcined at 550° C. for 4 h to obtain a metal-resistant catalyst A1, wherein, the microspheres with particle sizes in the range of 0-149 μm accounted for 95% by volume, and the microspheres with particle sizes in the range of 0-40 μm accounted for 15% by volume. The average particle size (APS) of the microspheres was 73 μm.

The formulation, the preparation parameters, the bulk density and the wear index of A1 are listed in Table 3.

### Example 4 (Pure Manganese Salt, a Higher Content of Alkaline Earth Metal)

(1) 50 g (based on Al₂O₃) of pseudo-boehmite were added to deionized water to formulate a slurry with a solid content of 14% by weight, which was stirred for 60 min at a condition of 300 r/min (referring to the stirring speed, the same below) to evenly disperse. Then, 9 g of hydrochloric acid (containing 35% by weight of HCl) were added, and stirred for 60 min at the condition of 250 r/min to fully peptize the acid-soluble first alumina material to give a first slurry.

(2) 20 g of manganese trichloride (based on MnO) were added to deionized water, fully dispersed and then added to the first slurry, and fully stirred before the addition of 10 g of CaO (based on a dry basis) and 20 g of non-acid-soluble second alumina material A (based on oxide) to give a second slurry with a solid content of 13% by weight;

(3) The second slurry was spray dried and molded, and then calcined at 550° C. for 4 h to obtain a metal-resistant catalyst A1, wherein, the microspheres with particle sizes in the range of 0-149 μm accounted for 91% by volume, and the microspheres with particle sizes in the range of 0-40 μm accounted for 19% by volume. The average particle size (APS) of the microspheres was 66 μm.

The formulation, the preparation parameters, the bulk density and the wear index of A1 are listed in Table 3.

### Comparative Example 1

(1) 60 g (based on Al₂O₃) of pseudo-boehmite and 30 g of non-acid-soluble second alumina material A (based on oxide) were added to deionized water to formulate a slurry with a solid content of 15% by weight, which was stirred for 60 min at a condition of 300 r/min to evenly disperse. Then, 12 g of hydrochloric acid (containing 35% by weight of HCl) were added, and then beaten and stirred for 60 min at the condition of 250 r/min to fully peptize the acid-soluble first alumina material to give a first slurry;
(2) 10 g of MgO (based on a dry basis) were added to the first slurry, fully stirred to then give a second slurry, which was spray dried and molded, and then calcined at 550° C. for 4 h to obtain a metal-resistant catalyst B1, wherein, the microspheres with particle sizes in the range of 0-149 μm accounted for 92% by volume, and the microspheres with particle sizes in the range of 0-40 μm accounted for 13% by volume. The average particle size (APS) of the microspheres was 79 μm.

### Comparative Example 2

(1) 120 g (based on Al₂O₃) of pseudo-boehmite were added to deionized water, fully dispersed, and then manganese oxide (containing 50 g MnO) was added, and dispersed evenly before hydrochloric acid was added, and after contacting for 30 min to give a first slurry with a pH value of 3 and a solid content of 12% by weight;
(2) Then, a deionized water-dispersed MgO slurry (containing 650 g of MgO) was added, and a second slurry with a pH value of 7.8 and a solid content of 18% by weight was obtained after 60 minutes of contact under a temperature controlled at 55° C.;
(3) Then, 180 g of non-acid-soluble second alumina A (based on Al₂O₃) were added to give a third slurry, and the contact at a room temperature (25° C.) lasted for 15 min;
(4) The third slurry was spray dried and molded before being directly calcined under the condition of 550° C./2 h to give a catalyst B2.

### Comparative Example 3

(1) 75 g (based on Al₂O₃) of pseudo-boehmite were formulated into a slurry with a solid content of 15% by weight, and beaten and stirred for 60 min at a condition of 300 r/min to evenly disperse. Then 15 g of hydrochloric acid (containing 35% by weight of HCl) were added, and then beaten and stirred for 60 min at a condition of 250 r/min and fully peptized to give a first slurry.
(2) Manganese trichloride (25 g calculated based on MnO) was added to deionized water, fully dissolved and then added to the first slurry, and further fully stirred to give a second slurry with a solid content of 13% by weight;
(3) The second slurry was spray dried and molded, and then calcined at 550° C. for 4 h to give a metal-resistant catalyst B3.

### Comparative Example 4 with Reference to the Examples of CN103785346B

(1) 65 g (based on Al₂O₃) of pseudo-boehmite were added to deionized water, dispersed evenly, and then manganese trichloride (containing 20 g of MnO) was added, and beaten and stirred at a condition of 250 r/min for 60 minutes. After a full dispersion, 15 g of hydrochloric acid were added, and beaten and stirred at a condition of 250 r/min for 30 minutes to give a first slurry with a solid content of 12% by weight;
(2) Then, 15 g of acid-soluble large-particle-size SB powder (soluble macroporous alumina) (based on Al₂O₃) were added, and beaten and stirred at a condition of 250 r/min for 60 minutes to give a third slurry.
(3) The third slurry was spray dried and molded before being directly calcined at 550° C./4 h to give a solid B4.

### Comparative Example 5

(1) 50 g (based on Al₂O₃) of pseudo-boehmite were added to deionized water to formulate a slurry with a solid content of 14% by weight, which was stirred for 60 min at a condition of 300 r/min (referring to the stirring speed, the same below) to evenly disperse. Then, 9 g of hydrochloric acid (containing 35% by weight of HCl) were added, and stirred for 60 min at the condition of 250 r/min to fully peptize the acid-soluble first alumina material to give a first slurry.
(2) 20 g of manganese trichloride (based on MnO) were added to deionized water, fully dispersed and then added to the first slurry, and fully stirred before the addition of 10 g of CaO (based on a dry basis) and 20 g of kaolin (based on solid oxide) to give a second slurry with a solid content of 13% by weight.
(3) The second slurry was spray dried and molded, and then calcined at 550° C. for 4 h to obtain a metal-resistant catalyst A1, wherein, the microspheres with particle sizes in the range of 0-149 μm accounted for 91% by volume, and the microspheres with particle sizes in the range of 0-40 μm accounted for 19% by volume. The average particle size (APS) of the microspheres was 66 μm.

The formulation, the preparation parameters, the bulk density and the wear index of A1 are listed in Table 3.

The formulations, the preparation parameters, the bulk densities and the wear indexes of B1, B3 and B4 are listed in Table 3.

TABLE 3

| | Example number | | | | | | |
|---|---|---|---|---|---|---|---|
| | | | | | Comparative | Comparative | Comparative |
| | Example 1 | Example 2 | Example 3 | Example 4 | Example 1 | Example 3 | Example 4 |
| metal pollution-resistant | A1 | A2 | A3 | A4 | B1 | B3 | B4 |
| catalyst number | | | | | | | |
| soluble alumina | 55 | 50 | 53 | 50 | 60 | 75 | 65 |
| content, % by weight | | | | | | | |
| non-acid-soluble second | 12 | 22 | 12 | 20 | 30 | 0 | 15 |
| alumina content, % by | | | | | | | |
| weight | | | | | | | |
| manganese salt based on | 10 | 10 | | 20 | | 25 | 20 |
| MnO, % by mass | | | | | | | |
| manganese ore | 18 | 18 | 30 | | | | |
| powder, % by mass | | | | | | | |
| modified metal oxide | 25 | 25 | 25 | 20 | 0 | 25 | 20 |
| content, % by weight | | | | | | | |
| alkaline earth metal oxide | 5 | 0 | 5 | 10 | 10 | 0 | 0 |
| content, % by weight | | | | | | | |
| integral area ratio of | 2.1:1 | 2.7:1 | 3:1 | 1.5:1 | 1:1.3 | 7.1:1 | 6.2:1 |
| peaks at wave numbers | | | | | | | |
| 3670 cm⁻¹ and 3730 cm⁻¹ | | | | | | | |
| in Infrared spectroscopy | | | | | | | |
| sodium oxide, % by | 0.25 | 0.24 | 0.28 | 0.21 | 0.22 | 0.26 | 0.24 |
| weight | | | | | | | |
| SiO₂, % by weight | 2.4 | 2.3 | 2.7 | 2.0 | 2.2 | 2.4 | 2.5 |
| specific surface area, | 142 | 178 | 156 | 154 | 151 | 128 | 138 |
| m²/g | | | | | | | |
| water drop pore volume, | 0.31 | 0.35 | 0.32 | 0.31 | 0.33 | 0.25 | 0.28 |
| ml/g | | | | | | | |
| bulk specific weight, g/ml | 0.89 | 0.84 | 0.92 | 0.85 | 0.96 | 1.25 | 1.13 |

### Examples 5-9

The metal pollution-resistant catalysts A1, A2, A3, A4, and A5 were respectively mixed with Cat-A at a weight ratio of 10:90 to give catalytic cracking catalysts C1, C2, C3, C4 and C5. These catalytic cracking catalysts were respectively subjected to a pollution on the ACE D100 device by using a cyclic pollution method, in which nickel naphthenate and vanadium naphthenate were dissolved in a distillate oil at a mass ratio of 5:2 for multiple cyclic reactions until the Ni on the catalyst reached approximately 4500 ppm (mass) and V reached 1800 ppm. The sample numbers of C1, C2, C3, C4, C5 after the cyclic pollution were Clw, C2w, C3w, C4w, C5w respectively. Then, the samples Clw-C5w were aged by a fixed bed at 800° C. and 100% by volume of water vapor for 15 hours, and then evaluated using an ACE fluidized bed device. The properties of the feedstock oil evaluated by ACE are shown in Table 4, and the evaluation conditions and the results are shown in Table 5.

### Comparative Examples 6-10

These examples illustrate the metal-resistant property of the catalyst for the heavy oil cracking provided by the present invention.

Catalyst Cat-A was mixed with B1, B2, B3 and B4 in a weight ratio of 90:10 to obtain the catalytic cracking catalysts D1, D2, D3 and D4. D1, D2, D3, D4 and Cat-A were respectively subjected to a pollution on the ACE D100 device by using a cyclic pollution method, in which nickel naphthenate and vanadium naphthenate were dissolved in a distillate oil at a mass ratio of 5:2 for multiple cyclic reactions until the Ni on the catalyst reached a mass of approximately 4500 ppm and V reached 1800 ppm. The sample numbers after the cyclic pollution were respectively D1w, D2w, D3w, D4w and Cat-Aw in sequence. The samples were then aged by a fixed bed at 800° C. and 100% water vapor for 15 hours, and then evaluated using an ACE fluidized bed device. The properties of the feedstock oil evaluated by ACE are shown in Table 3, and the evaluation conditions and the results are shown in Table 4.

### Comparative Example 11

To 200 g (based on a dry basis, a product of Shandong Aluminum Company) of pseudo boehmite, deionized water and 24 g of hydrochloric acid with a concentration of 35% by mass were added, and an acidified boehmite with a solid content of 12% by mass was prepared through beating; Then, 100 g (based on a dry basis) of an aluminum sol, 320 g (based on a dry basis) of kaolin, 20 g of manganese chloride (based on MnO) and 360 g (based on a dry basis) of DASY2.0 molecular sieve (a product of Qilu Branch of Sinopec Catalyst Co., Ltd.) were added, stirred for 0.5 h, spray dried, calcined at 550° C. for 2 h, then followed by washing with ammonium chloride solution with a concentration of 2% by mass twice to give a basic catalytic cracking catalyst precursor microsphere, which is recorded as Cat-E.

Cat-E was subjected to a pollution on the ACE D100 device by using a cyclic pollution method, in which nickel naphthenate and vanadium naphthenate were dissolved in a distillate oil at a mass ratio of 5:2 for multiple cyclic reactions until the Ni on the catalyst reached a mass of approximately 4500 ppm and V reached 1800 ppm. The sample number after the cyclic pollution was Cat-Ew respectively. The sample was then aged by a fixed bed at 800° C. and 100% water vapor for 15 hours, and then evaluated using an ACE fluidized bed device. The properties of the feedstock oil evaluated by ACE are shown in Table 3, and the evaluation conditions and the results are shown in Table 4.

TABLE 3

| | ACE evaluation |
|---|---|
| feedstock oil | Wuhan mixed feedstock oil |
| density (20° C.), g/cm³ | 0.9044 |
| refraction (20° C.) | 1.5217 |
| viscosity (100° C.) mm²/s | 9.96 |
| solidifying point, ° C. | 40 |
| aniline point, ° C. | 95.8 |
| C m % | 85.98 |
| H m % | 12.86 |
| S m % | 0.55 |
| N m % | 0.18 |
| carbon residue | 3.0 |
| distillation range, ° C. | |
| initial boiling point | 243 |
| 5% | 294 |
| 10% | 316 |
| 30% | 395 |
| 50% | 429 |
| 70% | 473 |
| 90% | — |

TABLE 4

| | Examples | | | | | | | | | |
|---|---|---|---|---|---|---|---|---|---|---|
| | Example | Example | Example | Example | Comparative | Comparative | Comparative | Comparative | Comparative | Comparative |
| | 5 | 6 | 7 | 8 | Example 10 | Example 6 | Example 7 | Example 8 | Example 9 | Example 11 |
| pollution | C1w | C2w | C3w | C4w | Cat-Aw | D1w | D2w | D3W | D4W | Cat-Ew |
| catalyst number | | | | | | | | | | |
| catalytic | 500 | 500 | 500 | 500 | 500 | 500 | 500 | 500 | 500 | 500 |
| cracking | | | | | | | | | | |
| reaction | | | | | | | | | | |
| temperature, | | | | | | | | | | |
| ° C. | | | | | | | | | | |
| ratio of catalyst | 4.02 | 4.02 | 4.02 | 4.02 | 4.02 | 4.02 | 4.02 | 4.02 | 4.02 | 4.02 |
| to oil, wt/wt | | | | | | | | | | |
| yield, wt %: | | | | | | | | | | |
| dry Gas | 1.57 | 1.61 | 1.76 | 1.56 | 1.96 | 1.84 | 1.88 | 1.82 | 1.74 | 1.78 |
| LPG | 12.57 | 12.54 | 12.74 | 12.45 | 12.22 | 12.55 | 12.23 | 12.38 | 12.41 | 12.17 |
| coke | 8.58 | 8.65 | 8.82 | 8.45 | 9.22 | 9.03 | 9.27 | 8.71 | 8.83 | 8.99 |
| gasoline | 37.94 | 37.96 | 38.27 | 37.27 | 35.73 | 34.76 | 37.46 | 36.06 | 36.57 | 34.09 |
| LCO | 16.78 | 16.83 | 16.25 | 17.12 | 17.91 | 17.97 | 16.67 | 18.30 | 17.82 | 18.75 |
| heavy oil | 22.56 | 22.41 | 22.15 | 23.15 | 22.96 | 23.85 | 22.46 | 22.73 | 22.63 | 24.22 |
| | 100.00 | 100.00 | 100.00 | 100.00 | 100.00 | 100 | 99.97 | 100 | 100 | 100 |
| H₂ | 0.17 | 0.18 | 0.21 | 0.16 | 0.45 | 0.36 | 0.41 | 0.31 | 0.32 | 0.36 |
| methane | 0.67 | 0.68 | 0.65 | 0.66 | 0.71 | 0.65 | 0.67 | 0.64 | 0.65 | 0.64 |
| conversion | | | | | | | | | | |
| rate, wt % | 60.66 | 60.76 | 61.60 | 59.73 | 59.13 | 58.18 | 60.84 | 58.97 | 59.55 | 57.03 |
| Ratio of | 2.03 | 2.12 | 2.58 | 1.94 | 5.07 | 4.43 | 4.90 | 3.88 | 3.94 | 4.50 |
| hydrogen | | | | | | | | | | |
| to methane | | | | | | | | | | |
| (molar ratio) | | | | | | | | | | |

It can be derived from the data in Table 4 that some comparative examples also have a certain property in terms of reducing the ratio of hydrogen to methane. However, the catalyst provided by the present invention, when used for the conversion of heavy oil after being mixed with conventional catalytic cracking catalysts, has a lower yield of hydrogen, a lower yield of dry gas, a lower yield of coke and an clearly lower ratio of hydrogen to methane, under the condition of vanadium and a high content of nickel pollution. In a preferred case, it has a higher conversion activity and higher yields of gasoline and the liquefied petroleum gas.

1. A composition for catalytic cracking of heavy oil, comprising an acid-soluble first alumina and a non-acid-soluble second alumina present in a weight ratio of greater than or equal to 2:1, the acid-soluble first alumina source having an acid solubility of more than 90%, and the non-acid-soluble second alumina having an acid solubility of less than 50%, wherein the acid solubility of the alumina is tested as follows:
mixing an alumina sample with water at a solid content of 10% to obtain a hydrous alumina, acidifying and dissolving the hydrous alumina and hydrochloric acid with a concentration of 35% by weight in a ratio of 1:0.2 by weight of dry alumina to hydrochloric acid at 25° C. for 60 minutes, followed by
separating an undissolved alumina using a centrifuge,
acid solubility=(1-dry weight of alumina not acidified and dissolved÷dry weight of alumina source sample)×100%.

2. The composition according to claim 1, wherein the acid-soluble first alumina and the non-acid-soluble second alumina are in a mass ratio of 5:1 to 20:1.

3. The composition according to claim 1, which further comprises a material containing a modified metal Mn, which, based on oxide MnO, accounts for 5-50% by weight, preferably 10-40% of a total weight of the material containing the modified metal Mn and the acid-soluble first alumina.

4. The composition according to claim 1, characterized in that the material containing the modified metal Mn originates from manganese ore and/or other manganese compounds, preferably, based on manganese oxide, a weight ratio of the manganese ore to the other manganese compounds being 5:1 to 1:5; the manganese ore includes one or more of soft manganese ore, hard manganese ore, water manganese ore, brown manganese ore, black manganese ore, rhodochrosite and a high-Mn intermediate industrial material such as electrolytic manganese; the manganese ore has a Mn content of greater than 60% based on MnO; the other manganese compounds are one or more of manganese salt, manganese hydroxide.

5. The composition according to claim 1, characterized in that the composition further comprises an alkaline earth metal oxide, the alkaline earth metal being one or more of Mg, Ca, Sr and Ba; the content of the alkaline earth metal, based on oxide, does not exceed 20% by weight, for example 2-10% by weight, of the metal-resistant catalyst.

6. The composition according to claim 5, characterized in that the alkaline earth metal originates from one or more of an alkaline earth metal hydroxide, an alkaline earth metal salt, an alkaline earth metal oxide, or a natural mineral containing an alkaline earth metal, such as hydrotalcite.

7. The composition according to claim 1, wherein the acid-soluble first alumina is in a form of a solid acid-soluble alumina or a form of an aluminum-containing sol;
the solid acid-soluble alumina is one or more of gibbsite, boehmite, pseudo boehmite, and bayerite, the aluminum-containing sol is selected from one or more of an amorphous aluminum gel, an aluminum sol and a phosphorus aluminum gel.

8. The composition according to claim 1, wherein the non-acid-soluble second alumina is a non-acid-soluble second alumina with a large particle size and a large pore size, the non-acid-soluble second alumina having an acid solubility of <35%, a median particle size of 1 μm-12 μm, preferably 4 μm-10 μm, an average pore size of 4 nm to 12 nm, a specific surface area of >230 m²/g, and/or a pore volume of >0.35 ml/g;
the non-acid-soluble second alumina is selected from one or more of pseudo boehmite, boehmite and γ alumina material.

9. The composition according to claim 1, characterized in that the composition further contains an additive oxide, which is selected from one or more of oxides of P, B, RE; the additive oxide is preferably added in a form of being fixed to the non-acid-soluble second alumina, and the content of the additive oxide in the non-acid-soluble second alumina is not more than 10% by weight, for example 0.5% by weight to 5% by weight, based on a total weight of the non-acid-soluble second alumina and the additive oxide; wherein, the oxide of P is based on P₂O₅, the oxide of B is based on B₂O₃, and the oxide of RE is based on RE₂O₃.

10. A metal pollution-resistant catalyst, which is obtained from the composition according to claim 1 through spray drying and calcining, wherein after calcined at 550° C. for 3-4 hours, the composition was tested for surface hydroxyl groups by using an infrared spectroscopy, and two peaks at 3670 cm⁻¹ and 3730 cm⁻¹ have a ratio of integral areas of 1-6:1.

11. The metal pollution-resistant catalyst according to claim 10, characterized in that the metal pollution-resistant catalyst has a bulk specific weight of 0.75-1.15 g/ml, a specific surface area of 100-250 m²/g, a water drop pore volume of 0.18-0.35 ml/g, preferably, the SiO₂ content in the catalyst does not exceed 3% by weight; preferably, the content of sodium oxide in the metal pollution-resistant catalyst does not exceed 0.3% by weight.

12. The metal pollution-resistant catalyst according to claim 11, characterized in that the acid-soluble first alumina in the metal pollution-resistant catalyst is present as a continuous phase, and Mn and the alkaline earth metal, when being contained, are distributed in a dispersed phase or uniformly in the continuous phase of the acid-soluble first alumina; the non-acid-soluble second alumina is present in a dispersed form, and is dispersed in the continuous phase of the acid-soluble first alumina.

13. A method for preparing the metal pollution-resistant catalyst according to claim 10, comprising following steps:
a first technical solution:
(1) forming a slurry of an acid-soluble first alumina, a non-acid-soluble second alumina, water and optionally acid to obtain a first slurry, and a solid content of the first slurry is preferably 8-20% by weight, preferably, a molar ratio of dissociable H to a total alumina source based on alumina in the first slurry is 0.05-0.3:1; the acid-soluble first alumina is a solid acid-soluble first alumina and/or an aluminum-containing colloid;
(2) adding a material containing a modified metal Mn, for example a manganese salt and a dispersion liquid containing manganese ore, to the first slurry obtained in step (1), stirring them evenly to form a second slurry; preferably, the formed second slurry has a solid content of 10-20% by weight.
(3) spray drying, calcining;
or, a second technical solution:
(S1) introducing a material containing a modified metal Mn to an acid-soluble first alumina to form a slurry having a solid content of 8-30% by weight, stirring to obtain a modified acid-soluble alumina source;
(S2) forming a third slurry of the modified acid-soluble alumina source, a non-acid-soluble second alumina, water and optionally acid, a solid content of the third slurry preferably being 10-20% by weight; preferably, a molar ratio of dissociable H⁺ to a total alumina source based on alumina in the third slurry is 0.05-0.3:1; the acid-soluble first alumina may be a solid acid-soluble first alumina and/or an aluminum-containing colloid;
(S3) spray drying and calcining the third slurry.

14. The method according to claim 13, characterized in that,
for the first technical solution: in step (1), the acid-soluble first alumina comprises a solid acid-soluble first alumina; an acid is added to the first slurry for acidifying and peptizing, wherein, a molar ratio of dissociable H⁺ in the acid to a sum of the solid acid-soluble first alumina and the non-acid-soluble second alumina based on alumina is 0.05-0.3:1;
for the second technical solution: in step (S1), the acid-soluble first alumina comprises a solid acid-soluble alumina; an acid is introduced to the third slurry in step (S2) for acidifying and peptizing, preferably, a molar ratio of dissociable H⁺ in the acid to a sum of the solid acid-soluble first alumina and the non-acid-soluble second alumina based on alumina is 0.05-0.3:1.

15. The method according to claim 13, characterized in that, based on alumina, in the first technical solution and the second technical solution separately, a weight ratio of the acid-soluble first alumina to the non-acid-soluble second alumina is 1.5:1-20:1 or 2:1-10:1.

16. The method according to claim 13, characterized in that, it further comprises a step of introducing an alkaline earth metal source which can be introduced in step (1) and/or step (2), or, the alkaline earth metal source is added in (S1) and/or (S2); the alkaline earth metal source is one or more of metal salt and/or metal oxide and/or hydroxide of Ca, Mg, Ba and Sr; the alkaline earth metal source is introduced in an amount such that a content of the alkaline earth metal in the metal pollution-resistant catalyst obtained is 0-20% by weight, for example, 0-10% by weight, based on oxide.

17. The method according to claim 13, characterized in that the manganese-containing ore is optionally ground to have a median particle size of 0.005-15 microns, preferably 1-10 microns; when used, a grinding method comprises a wet grinding, a dry grinding, a ball grinding, a sand grinding.

18. A catalytic cracking catalyst, comprising a microspherical particle containing a catalytic cracking active components and a metal pollution-resistant catalyst which is the metal pollution-resistant catalyst according to claim 10; a mass ratio of the metal pollution-resistant catalyst to the microspherical particle containing a catalytic cracking active component is 5:95-20:80.
